(19) United States
(12) Patent Application Publication
(10) Pub. No.: US 2025/0165619 A1
(43) Pub. Date: May 22, 2025

(54) METHOD AND APPARATUS FOR SECURITY PERFORMANCE EVALUATION FOR DETERMINING DEFENSIVE EXECUTION FUNCTION

(71) Applicant: Electronics and Telecommunications Research Institute, Daejeon (KR)

(72) Inventors: Gae-Il AN, Daejeon (KR); Dong-Wook KANG, Daejeon (KR); Hong-Il JU, Daejeon (KR)

(73) Assignee: Electronics and Telecommunications Research Institute, Daejeon (KR)

(21) Appl. No.: 18/919,914

(22) Filed: Oct. 18, 2024

(30) Foreign Application Priority Data
Nov. 20, 2023 (KR) 10-2023-0160284
May 31, 2024 (KR) 10-2024-0071204

(51) Int. Cl. G06F 21/57

(52) U.S. Cl. CPC G06F 21/577; G06F 2221/033

(57) ABSTRACT

Disclosed herein is a method for security performance evaluation for determining a defensive execution function. The method includes determining performance criteria data for a defensive execution function by performing static analysis of a protection target program, receiving a performance level specification for the defensive execution function, injecting the defensive execution function within a defensive execution function pool into the protection target program, injecting code for measuring the security performance of the defensive execution function into the protection target program, measuring the security performance data of the protection target program, and determining a combination of defensive execution functions within the defensive execution function pool based on the security performance data.

### CROSS REFERENCE TO RELATED APPLICATIONS

This application claims the benefit of Korean Patent Applications No. 10-2023-0160284, filed Nov. 20, 2023, and No. 10-2024-0071204, filed May 31, 2024, which are hereby incorporated by reference in their entireties into this application.

### BACKGROUND OF THE INVENTION

### 1. Technical Field

The present disclosure relates to technology for evaluating the performance of a security function capable of detecting and defending against attacks exploiting security vulnerabilities in a computer program.

More particularly, the present disclosure relates to technology for security performance evaluation based on which an optimal defensive execution function applicable to the computer program to be protected can be determined.

### 2. Description of the Related Art

Computer programs are very vulnerable to security issues due to the use of unsafe programming languages such as C/C++, etc., carelessness of programmers, and the like. As conventional technology for detecting and defending against attacks exploiting security vulnerabilities, there is defensive execution security technology. The defensive execution security technology is technology that enables software itself to detect and defend against attacks by checking control flow and data flow of a program for anomalies when it is executed. To this end, the defensive execution security technology uses a method of directly injecting attack detection code into the program to be protected. FIG. 1 is an example of the defensive execution security technology.

The defensive execution security technology may be categorized into a coarse-grained security technique and a fine-grained security technique. The coarse-grained security technique maintains a relatively consistent security service level regardless of the program to be protected, because performance overhead is small thanks to the simplicity of a defensive execution function and because program static analysis for determining the security performance of the defensive execution function is relatively simple. However, the coarse-grained security technique has a disadvantage of low security strength. The fine-grained security technique has very high security strength because of a sophisticated defensive execution function, but it has disadvantages of large performance overhead and an inconsistent security service level because program static analysis for determining the security performance of the defensive execution function may fail.

Meanwhile, programs to be protected have various security and performance requirements depending on the purpose of use. For example, programs used for financial systems may require a high level of security strength even if there is performance overhead. In the case of programs used for real-time systems, security is important, but a defensive execution function that can minimize performance overhead may be required.

The conventional defensive execution security technology can detect and defend against attacks exploiting security vulnerabilities in computer programs, but it does not clearly present a protection level and the degree of performance overhead. The reason for this is that the security level of a defensive execution function depends on the level and accuracy of static analysis of a program, and the more complex the program, the lower the level and accuracy of the static analysis. Similarly, figures related to the performance overhead of the defensive execution function are not clearly provided, because the number of security instructions performed for each program to be protected varies.

In other words, defensive execution functions have a fundamental problem in which they do not clearly present the security performance thereof, and do not provide a solution capable of satisfying various security performance requirements of programs to be protected.

Therefore, the conventional technology provides a method capable of detecting and defending against attacks exploiting security vulnerabilities in a program, but it does not provide technology for determining the optimal defensive execution function that satisfies the security performance required by the program to be protected, so a method capable of effectively solving this problem is required.

### [Documents of Related Art]

(Patent Document 1) Korean Patent No. 2567924, titled “Apparatus for protecting indirect call instruction in web assembly”.

### SUMMARY OF THE INVENTION

An object of the present disclosure is to evaluate the security performance of various levels of defensive execution functions and to thereby determine an optimal defensive execution function satisfying the security performance required by the program to be protected.

Another object of the present disclosure is to determine an optimal defensive execution function based on measurement of a security level and performance overhead.

In order to accomplish the above objects, a method for security performance evaluation for determining a defensive execution function according to an embodiment of the present disclosure includes determining performance criteria data for a defensive execution function by performing static analysis of a protection target program, receiving a performance level specification for the defensive execution function, injecting the defensive execution function within a defensive execution function pool into the protection target program, injecting code for measuring the security performance of the defensive execution function into the protection target program, measuring security performance data of the protection target program, and determining a combination of defensive execution functions within the defensive execution function pool based on the security performance data.

Here, the performance criteria data may include first criteria data for determining the overhead performance of the defensive execution function and second criteria data for determining the security performance of the defensive execution function.

Here, the performance level specification may include information about maximum performance overhead and a minimum security level when the defensive execution function is performed.

Here, the information about the minimum security level may include a minimum protection level, a maximum false negative level for attack detection, and a maximum false positive level for attack detection.

Here, injecting the code for measuring the security performance may comprise injecting code for extracting information about a protection target instruction, code for extracting information about a security setting instruction, and code for extracting information about a security check instruction.

Here, the information about the protection target instruction may include the location of the protection target instruction, the type of the protection target instruction, and the memory index information of the protection target instruction.

Here, the information about the security check instruction may include the number of security check instructions, the call target of the security check instruction, and the target candidate list information of the security check instruction.

Here, measuring the security performance data of the protection target program may comprise measuring security performance using performance overhead data and security determination data.

Here, measuring the security performance data of the protection target program may comprise determining whether the security performance data satisfies requirements in the performance level specification.

Here, the defensive execution function pool may include a type-based control flow integrity check function, a Control-Flow-Graph-(CFG-)based control flow integrity check function, an index-based control flow integrity check function, a location-based control flow integrity check function, and an identifier-based control flow integrity check function.

Also, in order to accomplish the above objects, an apparatus for security performance evaluation for determining a defensive execution function according to an embodiment of the present disclosure includes a performance criteria generation unit for determining performance criteria data for a defensive execution function by performing static analysis of a protection target program, a communication unit for receiving a performance level specification for the defensive execution function, a defensive execution function injection unit for injecting the defensive execution function within a defensive execution function pool into the protection target program, a trace code injection unit for injecting code for measuring the security performance of the defensive execution function into the protection target program, a performance measurement unit for measuring the security performance data of the protection target program, and a defensive execution function pool management unit for determining a combination of defensive execution functions within the defensive execution function pool based on the security performance data.

Here, the performance criteria data may include first criteria data for determining the overhead performance of the defensive execution function and second criteria data for determining the security performance of the defensive execution function.

Here, the performance level specification may include information about maximum performance overhead and a minimum security level when the defensive execution function is performed.

Here, the information about the minimum security level may include a minimum protection level, a maximum false negative level for attack detection, and a maximum false positive level for attack detection.

Here, the trace code injection unit may inject code for extracting information about a protection target instruction, code for extracting information about a security setting instruction, and code for extracting information about a security check instruction.

Here, the information about the protection target instruction may include the location of the protection target instruction, the type of the protection target instruction, and the memory index information of the protection target instruction.

Here, the information about the security check instruction may include the number of security check instructions, the call target of the security check instruction, and the target candidate list information of the security check instruction.

Here, the performance measurement unit may measure security performance using performance overhead data and security determination data.

Here, the performance measurement unit may determine whether the security performance data satisfies requirements in the performance level specification.

Here, the defensive execution function pool may include a type-based control flow integrity check function, a Control-Flow-Graph-(CFG-)based control flow integrity check function, an index-based control flow integrity check function, a location-based control flow integrity check function, and an identifier-based control flow integrity check function.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is an example of defensive execution security technology;

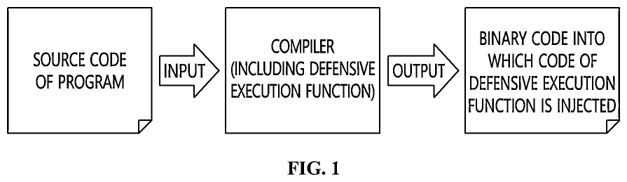

FIG. 2 is a flowchart illustrating a method for security performance evaluation for determining a defensive execution function according to an embodiment of the present disclosure;

FIG. 3 is an example of a structure diagram of an apparatus for security performance evaluation for determining an optimal defensive execution function;

FIG. 4 is an example of a structure of performance criteria data for a defensive execution function;

FIGS. 5 and 6 are examples of a data structure of a defensive execution function performance level specification;

FIG. 7 is an example of a defensive execution function pool;

FIG. 8 is an embodiment of a defensive execution function trace code injection unit;

FIG. 9 is an example of a structure of defensive execution function security performance delivery data;

FIG. 10 is an example of a structure of defensive execution function security performance measurement data;

FIG. 11 is a flowchart illustrating in detail a method for security performance evaluation for determining an optimal defensive execution function according to an embodiment of the present disclosure;

FIG. 12 is a flowchart illustrating in detail a method of injecting defensive execution function trace code;

FIG. 13 is a flowchart illustrating in detail a step of determining an optimal defensive execution function;

FIG. 14 is an embodiment of the present disclosure using a fuzzer;

FIG. 15 is a block diagram illustrating an apparatus for security performance evaluation for determining a defensive execution function according to an embodiment of the present disclosure; and

FIG. 16 is a view illustrating the configuration of a computer system according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

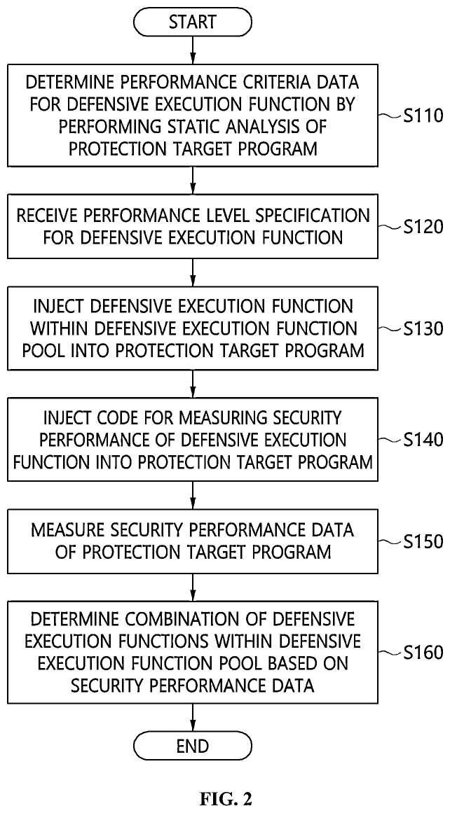

FIG. 2 is a flowchart illustrating a method for security performance evaluation for determining a defensive execution function according to an embodiment of the present disclosure.

The method for security performance evaluation for determining a defensive execution function according to an embodiment of the present disclosure may be performed by a security performance evaluation apparatus, such as a computing device or a server.

Referring to FIG. 2, the method for security performance evaluation for determining a defensive execution function according to an embodiment of the present disclosure includes determining performance criteria data for a defensive execution function by performing static analysis of a protection target program at step S110, receiving a performance level specification for the defensive execution function at step S120, injecting the defensive execution function within a defensive execution function pool into the protection target program at step S130, injecting code for measuring the security performance of the defensive execution function into the protection target program at step S140, measuring the security performance data of the protection target program at step S150, and determining a combination of defensive execution functions within the defensive execution function pool based on the security performance data at step S160.

Here, the performance criteria data may include first criteria data for determining the overhead performance of the defensive execution function and second criteria data for determining the security performance of the defensive execution function.

Here, the performance level specification may include information about maximum performance overhead and a minimum security level when the defensive execution function is performed.

Here, the information about the minimum security level may include a minimum protection level, a maximum false negative level for attack detection, and a maximum false positive level for attack detection.

Here, injecting the code for measuring the security performance at step S140 may comprise injecting code for extracting information about a protection target instruction, code for extracting information about a security setting instruction, and code for extracting information about a security check instruction.

Here, the information about the protection target instruction may include the location of the protection target instruction, the type of the protection target instruction, and the memory index information of the protection target instruction.

Here, the information about the security check instruction may include the number of security check instructions, the call target of the security check instruction, and the target candidate list information of the security check instruction.

Here, measuring the security performance data of the protection target program at step S150 may comprise measuring security performance using performance overhead data and security determination data.

Here, measuring the security performance data of the protection target program at step S150 may comprise determining whether the security performance data satisfies requirements in the performance level specification.

Here, the defensive execution function pool may include a type-based control flow integrity check function, a Control-Flow-Graph-(CFG-)based control flow integrity check function, an index-based control flow integrity check function, a location-based control flow integrity check function, and an identifier-based control flow integrity check function.

Also, the defensive execution function pool may further include a tag-based data flow integrity check function, a write integrity check function, a dedicated-instruction-based data flow integrity check function, an identifier-based data flow integrity check function, and a tag check optimization check function.

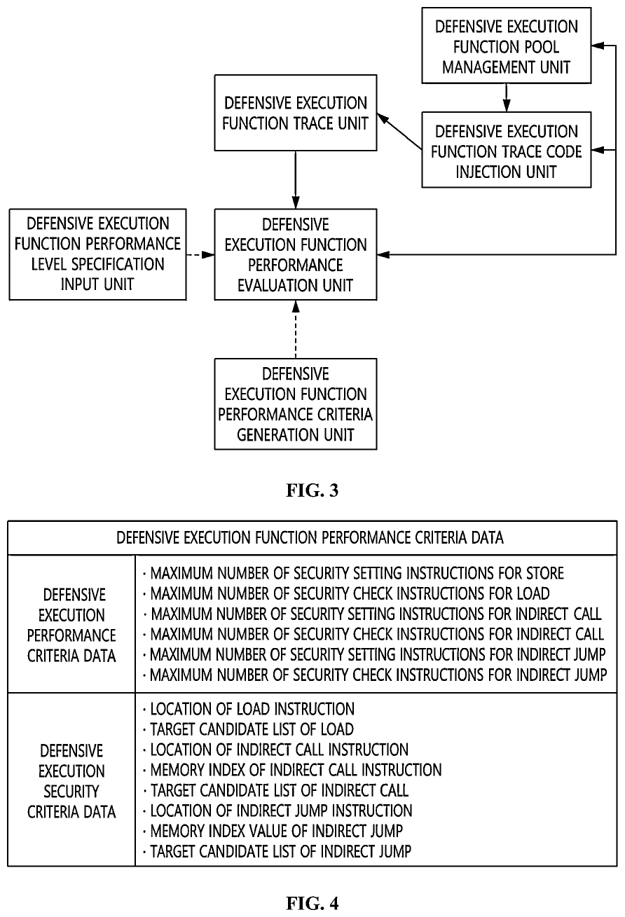

Hereinafter, an embodiment of the present disclosure will be described in more detail with reference to FIGS. 3 to 14.

FIG. 3 is an example of a structure diagram of an apparatus for security performance evaluation for determining an optimal defensive execution function.

Referring to FIG. 3, the structure of the apparatus for security performance evaluation for determining an optimal defensive execution function according to an embodiment of the present disclosure may include a defensive execution function performance criteria generation unit for generating performance criteria data for a defensive execution function by performing static analysis of a protection target program, a defensive execution function performance level specification input unit for receiving a user's performance level specification for the defensive execution function, a defensive execution function pool management unit for managing a defensive execution function pool containing defensive execution functions with different security levels, selecting a specific defensive execution function, and injecting the code of the defensive execution function into the protection target program, a defensive execution function trace code injection unit for generating code capable of measuring the security performance of a defensive execution function by analyzing the defensive execution function and injecting the code into the program, a defensive execution function trace unit for measuring security performance data while tracing a defensive executable function, and a defensive execution function performance evaluation unit for calculating the security performance of each defensive execution function based on the performance criteria data for the defensive execution function and determining the optimal defensive execution function satisfying the defensive execution function performance level specification based on the calculation result.

The defensive execution function performance criteria generation unit may include a function to generate criteria data based on which the degree of the performance overhead of a defensive execution function can be determined (that is, defensive execution performance criteria data) by setting the maximum performance overhead value of the defensive execution function and a function to generate criteria data for a defensive execution function to determine whether an attack is carried out (defensive execution security criteria data) through static analysis of the protection target program.

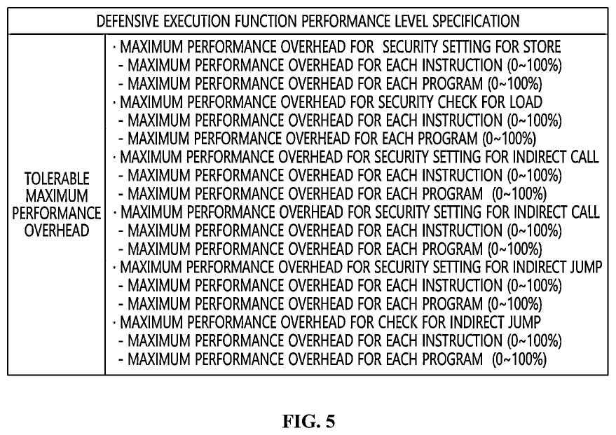

FIG. 4 is an example of a structure of performance criteria data for a defensive execution function. In FIG. 4, a load instruction, an indirect call instruction, and an indirect jump instruction are instructions containing security vulnerabilities and are protection target instructions for which a security check is performed for attack detection in a defensive execution function.

In the defensive execution function performance level specification input unit, the defensive execution function performance level specification may contain the maximum performance overhead and the minimum security level that are tolerable when a defensive execution function is performed.

The minimum security level may include a minimum protection level, a maximum false negative level for attack detection, and a maximum false positive level for attack detection, which indicate the minimum accuracy of the target candidate list used for attack detection.

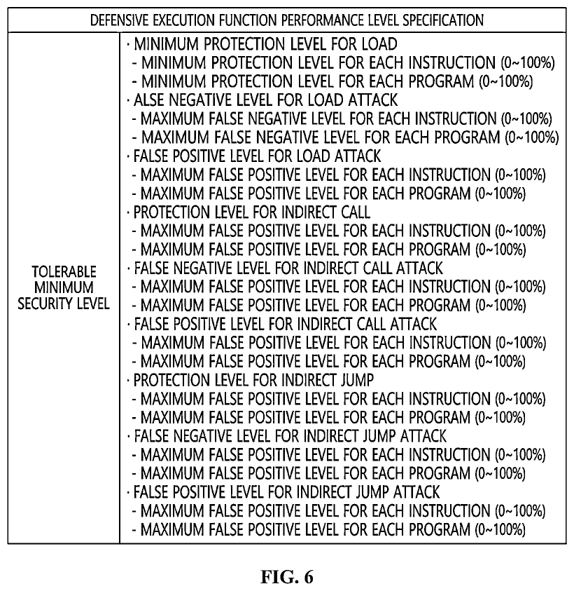

FIGS. 5 and 6 are examples of a data structure of a defensive execution function performance level specification.

Referring to FIGS. 5 and 6, the tolerable maximum performance overhead and the tolerable minimum security level may be defined by a user separately for individual protection target instructions and the entire protection target program.

In the defensive execution function pool management unit, the defensive execution function pool may be managed as a database. Here, a new defensive execution function may be added to the defensive execution function pool, or an existing defensive execution function may be removed therefrom.

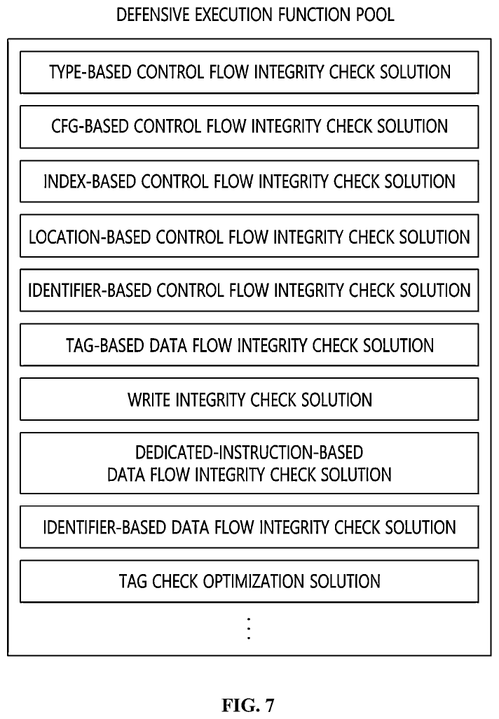

FIG. 7 is an example of a defensive execution function pool.

Referring to FIG. 7, the defensive execution function pool may include a type-based control flow integrity check function, a Control-Flow-Graph-(CFG-)based control flow integrity check function, an index-based control flow integrity check function, a location-based control flow integrity check function, an identifier-based control flow integrity check function, a tag-based data flow integrity check function, a write integrity check function, a dedicated-instruction-based data flow integrity check function, an identifier-based data flow integrity check function, and a tag check optimization function.

The defensive execution function trace code injection unit may provide a function to identify a protection target instruction (e.g., a store instruction, a load instruction, an indirect call instruction, and an indirect jump instruction) in the protection target program and to inject code for extracting information about the protection target instruction into the program. The extracted information about the protection target instruction may include the location of the protection target instruction, the type thereof (store, load, indirectCall, or indirectJump), and the memory index information thereof.

The defensive execution function trace code injection unit may also provide a function to identify the security setting instruction by the defensive execution function and to inject code for extracting the number of security setting instructions into the program.

Also, the defensive execution function trace code injection unit may provide a function to identify a security check instruction and inject code for extracting information about the security check instruction into the program. The extracted information about the security check instruction may include the number of security check instructions, the actual call target in the security check instruction, and target candidate list information in the security check instruction.

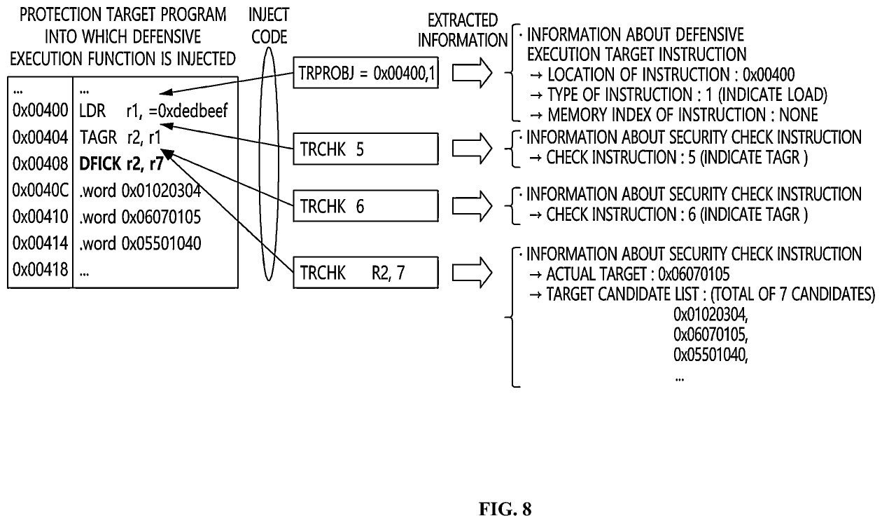

FIG. 8 is an embodiment of a defensive execution function trace code injection unit.

In the protection target program in FIG. 8, ‘TAGR’ and ‘DFICK’ are security check instructions injected by a defensive execution function. ‘TRPROBJ’, ‘TRCHK’, and ‘TRDFICK’ are instructions that are defined by the defensive execution function trace code injection unit according to the present disclosure in order to extract information about a defensive execution target instruction and information about a security check instruction.

The defensive execution function trace unit is operated by the defensive execution function trace code injected by the defensive execution function trace code injection unit, and may provide a function to measure the performance overhead data and the security determination data of a defensive execution function. The performance overhead data is performance overhead data generated by the code injected into the protection target program by the defensive execution function, and the security determination data is the data used by the defensive execution function to determine whether an attack is carried out and attack detection result data.

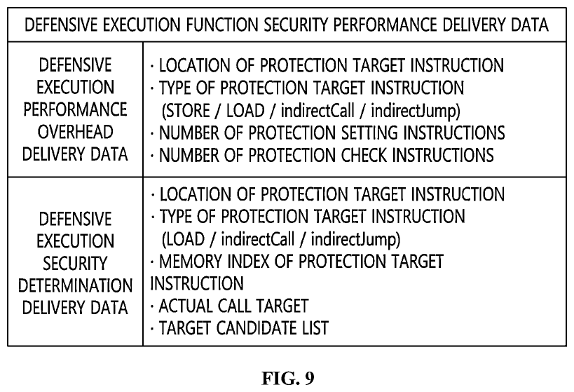

FIG. 9 is an example of a structure of defensive execution function security performance delivery data.

Each time new security performance data is measured, the defensive execution function trace unit also performs a function to packetize the security performance data and deliver the same to the defensive execution function performance evaluation unit. FIG. 9 is an example of the structure of defensive execution function security performance delivery data transmitted from the defensive execution function trace unit to the defensive execution function performance evaluation unit.

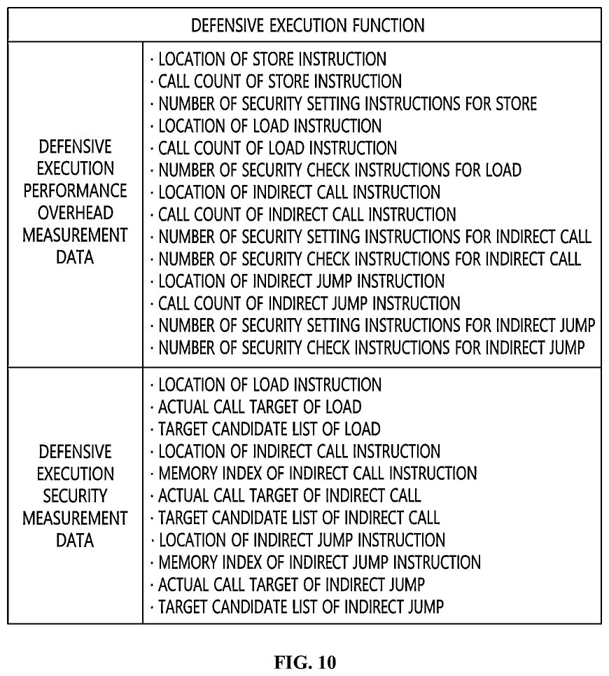

FIG. 10 is an example of a structure of defensive execution function security performance measurement data.

When it receives the defensive execution function security performance delivery data from the defensive execution function trace unit, the defensive execution function performance evaluation unit may construct defensive execution function security performance measurement data using the received data.

The defensive execution function security performance measurement data may include defensive execution performance overhead measurement data and defensive execution security measurement data. The defensive execution performance overhead measurement data may include information about the location and call count of a protection target instruction and the number of security setting instructions, and the defensive execution security measurement data may include information about the location, the actual call target, and the target candidate list of the protection target instruction.

For the constructed defensive execution function security performance measurement data, the defensive execution function performance evaluation unit may provide a function to calculate security performance for the protection target instruction and the protection target program based on the defensive execution function performance criteria data. The security performance calculation method performed by the defensive execution function performance evaluation unit may include a function to calculate performance overhead, a protection level, a false negative level for attack detection, and a false positive level for attack detection. Equations (1) to (4) below are examples of the method of calculating the performance overhead, the protection level, the false negative level, and the false positive level for the protection target instruction.

$$( 1 )$$

$$performance overhead = \frac{defensive execution performance overhead measurement data}{defensive execution performance criteria data} \times 100$$

$$( 2 )$$

$$protection level = \frac{\begin{matrix}n ( defensive execution security criteria data ⋂ \\ defensive execution security measurement data )\end{matrix}}{n ( defensive execution security criteria data )} \times 100$$

$$( 3 )$$

$$false negative level = \frac{\begin{matrix}n ( defensive execution security measurement data - \\ defensive execution security criteria data )\end{matrix}}{n ( defensive execution security measurement data )} \times 100$$

$$( 4 )$$

$$false positive level = \frac{\begin{matrix}n ( defensive execution security criteria data - \\ defensive execution security measurement data )\end{matrix}}{n ( defensive execution security measurement data )} \times 100$$

Equations (5) to (8) below are examples of a method for calculating the performance overhead, the protection level, the false negative level, and the false positive level for the protection target program.

$$\begin{matrix}\begin{matrix}overall\_performance \\ overhead\end{matrix} = protection\_target \_instruction1 \_performance \_ \\ overhead \\ * protection\_target \_instruction1 \_call \_ frequency \\ + protection\_target \_instruction2 \_performance \_ \\ overhead \\ * protection\_target \_instruction2 \_call \_frequency \\ … \\ + protection\_target \_instructionn \_performance \_ \\ overhead \\ * protection\_target \_instructionn \_call \_frequency\end{matrix} \qquad ( 5 )$$

$$\begin{matrix}\begin{matrix}overall protection \\ level\end{matrix} = protection\_target \_instruction1 \_protection \_level \\ * protection\_target \_instruction1 \_call \_frequency \\ + protection\_target \_instruction2 \_protection \_level \\ * protection\_target \_instruction2 \_call \_frequency \\ … \\ + protection\_target \_instructionn \_protection \_level \\ * protection\_target \_instructionn \_call \_frequency\end{matrix} \qquad ( 6 )$$

$$\begin{matrix}\begin{matrix}overall false \\ negative level\end{matrix} = protection\_target \_instruction1 \_false \_negative \_level \\ * protection\_target \_instruction1 \_call \_frequency \\ + protection\_target \_instruction2 \_false \_negative \_level \\ * protection\_target \_instruction2 \_call \_frequency \\ … \\ + protection\_target \_instructionn \_false \_negative \_level \\ * protection\_target \_instructionn \_call \_frequency\end{matrix} \qquad ( 7 )$$

$$\begin{matrix}\begin{matrix}overall false \\ positive level\end{matrix} = protection\_target \_instruction1 \_false \_positive \_level \\ * protection\_target \_instruction1 \_call \_frequency \\ + protection\_target \_instruction2 \_false \_positive \_level \\ * protection\_target \_instruction2 \_call \_frequency \\ … \\ + protection\_target \_instructionn \_false \_positive \_level \\ * protection\_target \_instructionn \_call \_frequency\end{matrix} \qquad ( 8 )$$

Hereinafter, an example of calculating security performance for a protection target instruction and a protection target program using Equations (1) to (8) above will be described. Data for protection target instruction 1 is defined as follows:

Defensive execution function performance criteria data
maximum number of security check instructions for load=20
target candidate list for load={a, b, c, d}

Defensive execution function security performance measurement data
number of security check instructions for load=12
target candidate list for load={a, b, c, x, y}

The method of calculating security performance for protection target instruction 1 may be performed as follows:

$$performance overhead = ( 12 / 20 ) * 100 = 60 \%$$

$$protection level = n ( \{ a , b , c , d \} ⋂ \{ a , b , c , x , y \} ) / n ( \{ a , b , c , d \} ) * 100 = ( 3 / 5 ) * 100 = 75 \%$$

$$false negative level = n ( \{ a , b , c , x , y \} - \{ a , b , c , d \} ) / n ( \{ a , b , c , x , y \} ) * 100 = ( 2 / 5 ) * 100 = 40 \%$$

$$false positive level = n ( \{ a , b , c , d \} - \{ a , b , c , x , y \} ) / n ( \{ a , b , c , x , y \} ) * 100 = ( 1 / 5 ) * 100 = 20 \%$$

The frequency of occurrence of the protection target instruction and the protection level thereof may be assumed as follows:
call frequency of protection target instruction 1: 2/4
call frequency of protection target instruction 2: 1/4
call frequency of protection target instruction 3: 1/4
protection level of protection target instruction 1: 60%
protection level of protection target instruction 2: 40%
protection level of protection target instruction 3: 20%

Here, the overall protection level of the security performance for the protection target program may be calculated as follows. Also, the overhead, the false negative level, and the false positive level may be calculated in a similar manner.

$$overall protection level = 60 * ( 2 / 4 ) + 40 * ( 1 / 4 ) + 20 * ( 1 / 4 ) = 45 \%$$

After calculating the performance overhead and the security level of the defensive execution function performed in the protection target program, the defensive execution function performance evaluation unit may provide a function to check whether the calculated performance overhead and security level satisfy the input defensive execution function security level specification.

When the defensive execution function security level specification is satisfied, it is determined that the defensive execution function currently being performed in the protection target program is the optimal defensive execution function. When the defensive execution function security level specification is not satisfied, the defensive execution function pool management unit is requested to inject a new defensive execution function into the protection target program, whereby measurement and evaluation of the defensive execution function may be newly started.

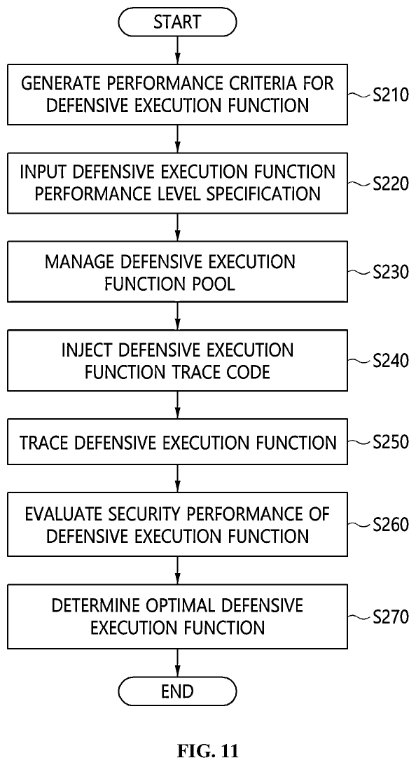

FIG. 11 is a flowchart illustrating in detail a method for security performance evaluation for determining an optimal defensive execution function according to an embodiment of the present disclosure.

Referring to FIG. 11, the method for security performance evaluation for determining an optimal defensive execution function according to the present disclosure includes a defensive execution function performance criteria generation step (S210) for generating criteria to be used to evaluate the security performance of a defensive execution function, a defensive execution function performance level specification input step (S220) for receiving a performance level specification of the defensive execution function required by a protection target program, a defensive execution function pool management step (S230) for managing defensive execution functions with different levels and injecting defensive execution function code into the protection target program, a defensive execution function trace code injection step (S240) for injecting code that is capable of measuring security performance by tracing the defensive execution function into the protection target program, a defensive execution function trace step (S250) for measuring security performance data while tracing the defensive execution function when the protection target program is executed, a defensive execution function security performance evaluation step (S260) for evaluating the security performance of the defensive execution function using the defensive execution function performance criteria and the security performance data received at the defensive execution function trace step, and an optimal defensive execution function determination step (S270) for determining an optimal defensive execution function using the evaluated security performance of the defensive execution function and the defensive execution function performance level specification.

The defensive execution function performance criteria generation step may include a method of generating criteria data based on which the performance overhead of the defensive execution function can be determined by setting the maximum performance overhead of the defensive execution function and a method of generating criteria data based on which the defensive execution function is able to determine whether an attack is carried out by performing static analysis of the protection target program.

The defensive execution function performance level specification, which is input at the defensive execution function performance level specification input step, may include maximum performance overhead and a minimum security level that are tolerable when the defensive execution function is performed.

At the defensive execution function pool management step, the defensive execution functions may be managed as a database. A new defensive execution function may be added to the database, or an existing defensive execution function may be removed therefrom.

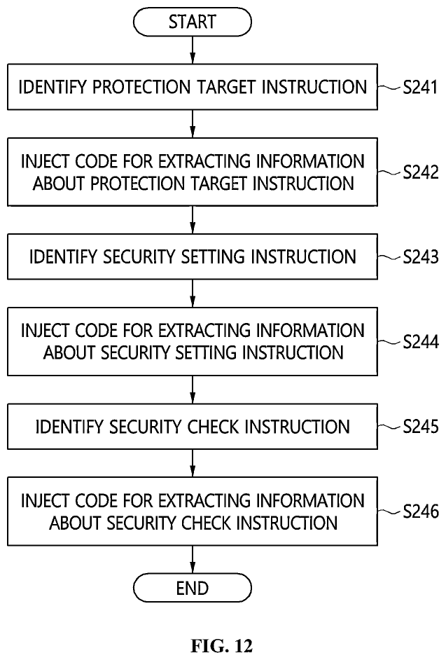

FIG. 12 is a flowchart illustrating in detail a method of injecting defensive execution function trace code.

At the defensive execution function trace code injection step, a protection target instruction (e.g., a store instruction, a load instruction, an indirect call instruction, and indirect jump instruction) is identified in the protection target program at step S241, and code for extracting information about the protection target instruction may be injected into the program at step S242. The extracted information about the protection target instruction may include the location of the protection target instruction, the type of the protection target instruction (store, load, indirectCall, or indirectJump), and the memory index information of the protection target instruction.

At the defensive execution function trace code injection step, a security setting instruction injected by the defensive execution function is identified at step S243, after which code for extracting the number of security setting instructions may be injected into the program at step S244.

Also, at the defensive execution function trace code injection step, a security check instruction is identified at step S245, after which code for extracting information about the security check instruction may be injected into the program at step S246. The extracted information about the security check instruction may include the number of security check instructions, the actual call target in the security check instruction, and the target candidate list information in the security check instruction.

The defensive execution function trace step is operated by the defensive execution function trace code injected at the defensive execution function trace code injection step, and performance overhead data and security determination data may be measured. The performance overhead data is data on the performance overhead caused by the code injected into the protection target program by the defensive execution function, and the security determination data is data used by the defensive execution function to determine whether an attack is carried out and attack detection result data.

Also, at the defensive execution function trace step, each time new security performance data is measured, the data may be packetized and provided to the defensive execution function security performance evaluation step.

At the defensive execution function performance evaluation step, security performance for the protection target instruction and the protection target program may be calculated using the defensive execution function performance criteria data for the defensive execution function security performance data received from the defensive execution function trace unit. The method of calculating the security performance for the protection target instruction and the protection target program has been described through Equations (1) to (8) above.

By the security performance calculation method performed at the defensive execution function performance evaluation step, performance overhead, a protection level, a false negative level for attack detection, and a false positive level for attack detection may be calculated.

At the optimal defensive execution function determination step, if the evaluated security performance of the defensive execution function satisfies the defensive execution function performance level specification, the current defensive execution function is determined to be the optimal defensive execution function, but if not, a new defensive execution function may be selected, and security performance may be evaluated again.

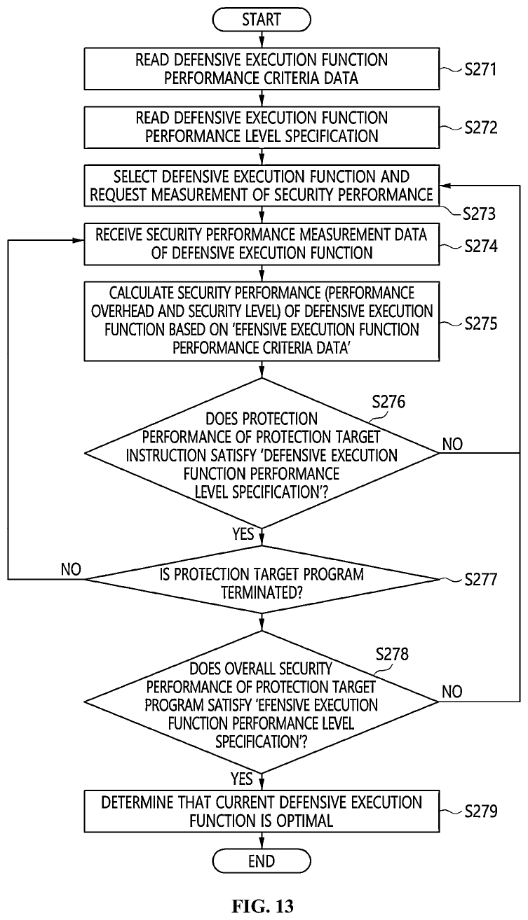

FIG. 13 is a flowchart illustrating in detail an optimal defensive execution function determination step.

In the method for determining an optimal defensive execution function according to the present disclosure, first, ‘defensive execution function performance criteria data’ and a ‘defensive execution function performance level specification’ are prepared at steps S271 and S272, one of defensive execution functions is selected, and tracing the defensive execution function is requested at step S273. Upon receiving security performance measurement data for the traced defensive execution function, the performance overhead and security level of the defensive execution function are calculated using the ‘defensive execution function performance criteria data’ at steps S724 and S275. When the calculated performance overhead and security level do not satisfy the ‘defensive execution function performance level specification’, the current defensive execution function is terminated, and measurement of the security performance of another defensive execution function is requested at step S276. When the performance overhead and security level (that is, a protection level, a false negative level for attack detection, and a false positive level for attack detection) calculated for all of the protection target instructions satisfy the ‘defensive execution function performance level specification’ and when the performance overhead and the security level calculated for the entire protection target program satisfy the ‘defensive execution function performance level specification’, the current defensive execution function is determined to be the optimal defensive execution function at steps S278 and S279.

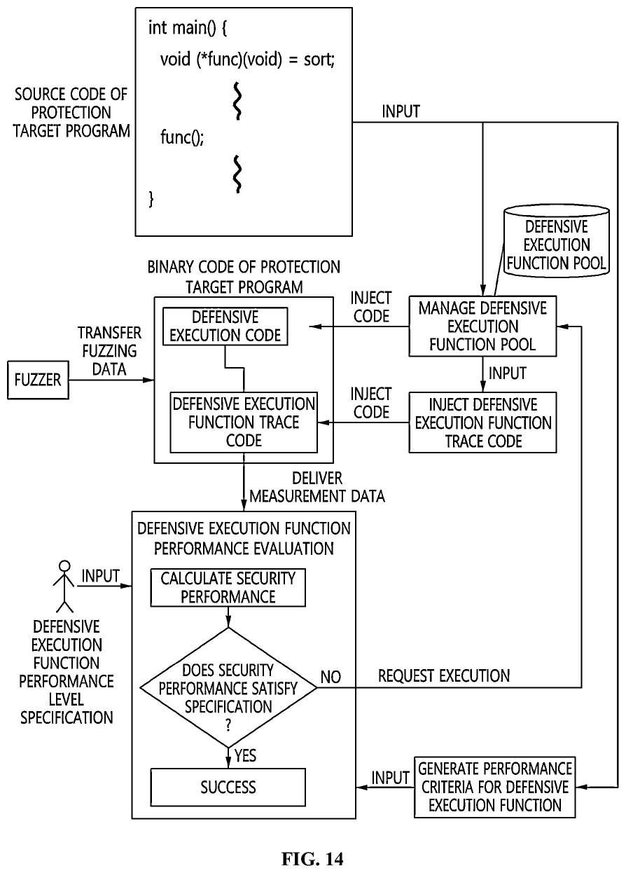

FIG. 14 is an embodiment of the present disclosure using a fuzzer.

The fuzzer is technology that sends manipulated communication messages to the software under test and thereby detects an error or a defect in the software, and the security level and performance overhead of a defensive execution function may be measured using the fuzzer.

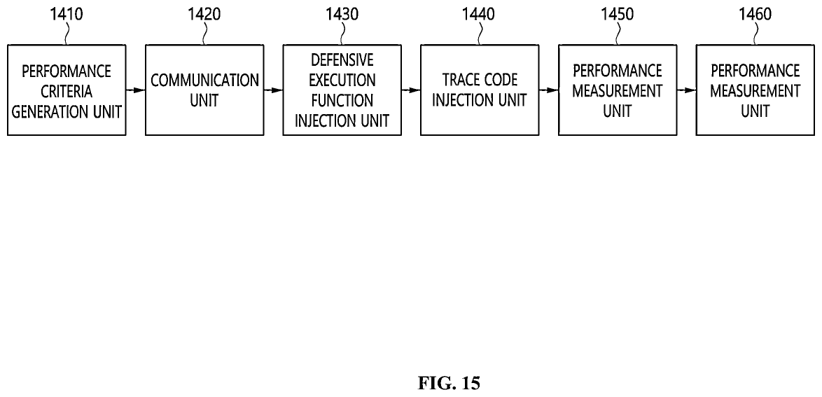

FIG. 15 is a block diagram illustrating an apparatus for security performance evaluation for determining a defensive execution function according to an embodiment of the present disclosure.

Referring to FIG. 15, the apparatus for security performance evaluation for determining a defensive execution function according to an embodiment of the present disclosure includes a performance criteria generation unit for determining performance criteria data for a defensive execution function through static analysis of a protection target program, a communication unit for receiving a performance level specification for the defensive execution function, a defensive execution function injection unit for injecting the defensive execution function within a defensive execution function pool into the protection target program, a trace code injection unit for injecting code for measuring the security performance of the defensive execution function into the protection target program, a performance measurement unit for measuring the security performance data of the protection target program, and a defensive execution function pool management unit for determining a combination of defensive execution functions within the defensive execution function pool based on the security performance data.

Here, the performance criteria data may include first criteria data for determining the overhead performance of the defensive execution function and second criteria data for determining the security performance of the defensive execution function.

Here, the performance level specification may include information about maximum performance overhead and a minimum security level when the defensive execution function is performed.

Here, the information about the minimum security level may include a minimum protection level, a maximum false negative level for attack detection, and a maximum false positive level for attack detection.

Here, the trace code injection unit may inject code for extracting information about a protection target instruction, code for extracting information about a security setting instruction, and code for extracting information about a security check instruction.

Here, the information about the protection target instruction may include the location of the protection target instruction, the type of the protection target instruction, and the memory index information of the protection target instruction.

Here, the information about the security check instruction may include the number of security check instructions, the call target of the security check instruction, and the target candidate list information of the security check instruction.

Here, the performance measurement unit may measure security performance using performance overhead data and security determination data.

Here, the performance measurement unit may determine whether the security performance data satisfies requirements in the performance level specification.

Here, the defensive execution function pool may include a type-based control flow integrity check function, a Control-Flow-Graph-(CFG-)based control flow integrity check function, an index-based control flow integrity check function, a location-based control flow integrity check function, and an identifier-based control flow integrity check function.

Also, the defensive execution function pool may further include a tag-based data flow integrity check function, a write integrity check function, a dedicated-instruction-based data flow integrity check function, an identifier-based data flow integrity check function, and a tag check optimization check function.

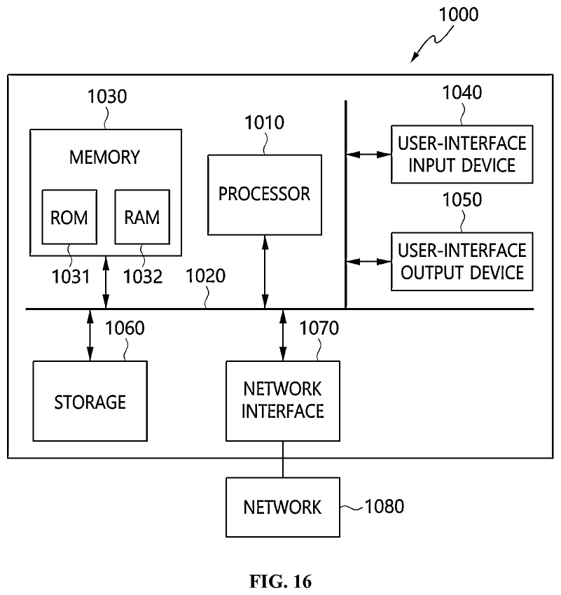

FIG. 16 is a view illustrating the configuration of a computer system according to an embodiment.

The apparatus for security performance evaluation for determining a defensive execution function according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the present disclosure, an optimal defensive execution function satisfying the security performance required by the program to be protected may be determined through evaluation of the security performance of various levels of defensive execution functions.

Also, the present disclosure may determine an optimal execution function based on measurement of a security level and performance overhead.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for security performance evaluation for determining a defensive execution function, comprising:
determining performance criteria data for a defensive execution function by performing static analysis of a protection target program;
receiving a performance level specification for the defensive execution function;
injecting the defensive execution function within a defensive execution function pool into the protection target program;
injecting code for measuring security performance of the defensive execution function into the protection target program;
measuring security performance data of the protection target program; and
determining a combination of defensive execution functions within the defensive execution function pool based on the security performance data.

2. The method of claim 1, wherein the performance criteria data includes
first criteria data for determining overhead performance of the defensive execution function; and
second criteria data for determining the security performance of the defensive execution function.

3. The method of claim 2, wherein the performance level specification includes information about maximum performance overhead and a minimum security level when the defensive execution function is performed.

4. The method of claim 3, wherein the information about the minimum security level includes a minimum protection level, a maximum false negative level for attack detection, and a maximum false positive level for attack detection.

5. The method of claim 1, wherein injecting the code for measuring the security performance comprises injecting code for extracting information about a protection target instruction, code for extracting information about a security setting instruction, and code for extracting information about a security check instruction.

6. The method of claim 5, wherein the information about the protection target instruction includes a location of the protection target instruction, a type of the protection target instruction, and memory index information of the protection target instruction.

7. The method of claim 5, wherein the information about the security check instruction includes a number of security check instructions, a call target of the security check instruction, and target candidate list information of the security check instruction.

8. The method of claim 1, wherein measuring the security performance data of the protection target program comprises measuring security performance using performance overhead data and security determination data.

9. The method of claim 1, wherein measuring the security performance data of the protection target program comprises determining whether the security performance data satisfies requirements in the performance level specification.

10. The method of claim 1, wherein the defensive execution function pool includes a type-based control flow integrity check function, a Control-Flow-Graph-(CFG-)based control flow integrity check function, an index-based control flow integrity check function, a location-based control flow integrity check function, and an identifier-based control flow integrity check function.

11. An apparatus for security performance evaluation for determining a defensive execution function, comprising:
a performance criteria generation unit for determining performance criteria data for a defensive execution function by performing static analysis of a protection target program;
a communication unit for receiving a performance level specification for the defensive execution function;
a defensive execution function injection unit for injecting the defensive execution function within a defensive execution function pool into the protection target program;
a trace code injection unit for injecting code for measuring security performance of the defensive execution function into the protection target program;
a performance measurement unit for measuring security performance data of the protection target program; and
a defensive execution function pool management unit for determining a combination of defensive execution functions within the defensive execution function pool based on the security performance data.

12. The apparatus of claim 11, wherein the performance criteria data includes
first criteria data for determining overhead performance of the defensive execution function; and
second criteria data for determining the security performance of the defensive execution function.

13. The apparatus of claim 12, wherein the performance level specification includes information about maximum performance overhead and a minimum security level when the defensive execution function is performed.

14. The apparatus of claim 13, wherein the information about the minimum security level includes a minimum protection level, a maximum false negative level for attack detection, and a maximum false positive level for attack detection.

15. The apparatus of claim 11, wherein the trace code injection unit injects code for extracting information about a protection target instruction, code for extracting information about a security setting instruction, and code for extracting information about a security check instruction.

16. The apparatus of claim 15, wherein the information about the protection target instruction includes a location of the protection target instruction, a type of the protection target instruction, and memory index information of the protection target instruction.

17. The apparatus of claim 15, wherein the information about the security check instruction includes a number of security check instructions, a call target of the security check instruction, and target candidate list information of the security check instruction.

18. The apparatus of claim 11, wherein the performance measurement unit measures security performance using performance overhead data and security determination data.

19. The apparatus of claim 11, wherein the performance measurement unit determines whether the security performance data satisfies requirements in the performance level specification.

20. The apparatus of claim 11, wherein the defensive execution function pool includes a type-based control flow integrity check function, a Control-Flow-Graph-(CFG-) based control flow integrity check function, an index-based control flow integrity check function, a location-based control flow integrity check function, and an identifier-based control flow integrity check function.
